(19) United States
(12) Patent Application Publication
(10) Pub. No.: US 2015/0013518 A1
(43) Pub. Date: Jan. 15, 2015

(54) Composition And Tool For Cutting Metal Sheets

(71) Applicant: Ford Global Technologies, LLC, Dearborn, MI (US)

(72) Inventors: Torsten Hallfeldt, Eschweiler (DE); Raymund Eugen Pflitsch, Engelskirchen (DE); Angelo Pintus, Kerpen (DE); Frank Schreiber, Kalkar (DE); Alfons Fischer, Essen (DE)

(21) Appl. No.: 14/331,931

(22) Filed: Jul. 15, 2014

(30) Foreign Application Priority Data
Jul. 15, 2013 (DE) 10 2013 213 752.4

(51) Int. Cl. B23K 35/30; B21D 28/00

(52) U.S. Cl. CPC B23K 35/3093; B21D 28/00; C22C 38/56
USPC 83/651; 420/10; 420/101

(57) ABSTRACT

The invention relates to a tool (1) and a method for producing a tool (1) for the machining of metal sheets, in particular, for the trimming or forming thereof by means of deep drawing. The method comprises the provision of a metallic basic body (2), onto which a welding material (9) is welded at least in regions. According to the invention, the welding material (9) is composed of an alloy in % by mass of:

| | |
|---|---|
| carbon (C) | 1.5-1.8% |
| vanadium (V) | 7.5-9.0% |
| chromium (Cr) | 4.5-6.0% |
| molybdenum (Mo) | 1.0-2.5% |
| nickel (Ni) | lower than (<)0.5% |
| manganese (Mn) | lower than (<)1.0% |
| silicon (Si) | lower than (<)1.0% |

as well as a remainder of iron (Fe) and melt-induced impurities.

### CROSS REFERENCE TO RELATED APPLICATION

This application claims foreign priority benefits under 35 U.S.C. §119 1d to DE102013213752.4, filed Jul. 15, 2013, which is hereby incorporated by reference in its entirety.

### FIELD OF THE INVENTION

The present invention relates to a method for the production of a tool for the machining of metal sheets, comprising the provision of a metallic basic body, onto which a welding material is welded, at least in regions, wherein the welding material is welded onto the basic body in order to form a cutting edge.

### BACKGROUND OF THE INVENTION

Sheet metal tools often have both a cutting and/or forming function, and are used in the shaping of materials and work pieces. Drawing tools are employed for the straightforward forming of metal sheets, while cutting functions are carried out with the aid of cutting tools. In addition to rotating cutting tools, cutting tools may also be rigidly connected to a machine which executes lifting movements. The separating operation then occurs, depending on the configuration of the cutting tool, by either a chip-removing or splitting method. Tools that make cuts using the splitting method have a geometrically defined cutting edge. For example, the tool's cutting edge may take the form of the tool's edge.

The progressive development of higher-strength metal sheets necessitates a constant improvement in the sheet metal tools used to process them. The automobile industry places stringent requirements upon the dimensional stability, road stability, and efficiency of the tools used in the processing of sheet metals. Against the background of high tool costs and outage times that occur during tool exchange, the aim of the invention is to manufacture tools which can produce as many machined metal sheets as possible. The tools used should afford a simple and durable possibility for their repair and regeneration.

To increase the wear resistance of cutting and shaping tools, they are sometimes manufactured entirely from high-alloy materials. In order to obtain tools which are as strong and finely structured as possible, powder-metallurgical production methods are employed. In addition to high material costs, the repair of these tools may only be done in a restricted fashion, if at all. When any surface and/or repair welds are applied, only the reworked region comes into contact with the metal sheets. After being reworked, these regions lose their original advantageous strength. The entire tool made from costly material must then be replaced.

Additional difficulties arise when further surface modifications have to be carried out on such tools. For example, cambering, which is done through a build-up layer, is used to improve the drawing flow of the material in a drawing tool. When only a minimal build-up thickness is required, the build-up layer must have innate high wear resistance while remaining machinable. The build-up layer should be capable of being applied as thinly as possible without the introduction of spatters. Since it is not possible for the entire tool to be subsequently hardened in a furnace, the build-up layer itself must be sufficiently hard.

In order to increase the efficiency of sheet metal tools, particularly in the production thereof, further methods and embodiments are known from the prior art. The prior art shows, for example, the use of a cost-effective base or basic body which is combined with a comparatively harder or hardened cutting region.

DE102007044662 A1 discloses a cutting tool, as well as a method for producing a cutting tool, for the trimming of metal sheets. The cutting tool has a basic body made from cost-effective cast iron. The subregion of the cutting tool which exists for the trimming of metal sheets is designed as a cutting edge. The cutting edge is made from a material which is harder than the cast iron of the basic body. A plurality of weld seams are welded onto the basic body in order to form the cutting edge. These weld seams are arranged so as to be both next to one another and above one another, and are subsequently machined in order to reduce stress. An additional material, which is suitable for the welding of cast iron, may be used to weld the harder material onto the basic body. To form the cutting edge, a recess in the basic body may be provided where at least some of the weld seams are applied. When the cutting edge is worn or damaged, it may be regenerated by the welding on of new weld seams without the alteration of the cast iron basic body.

DE19530641C1 likewise discloses a cutting tool for the cutting of paper, as well as a method for producing and regenerating the cutting tool. The cutting tool has a cutting edge with higher hardness than its cost-effective tempered steel basic body. The cutting edge is formed as a build-up layer on the basic body through a beam-assisted welding method which embeds the hard phases within the metal matrix. The build-up layer is preferably composed of an iron, nickel, or cobalt base matrix in which hard phases are embedded in a 5% to 80% volume fraction. The proposed welding method may be carried out with the aid of, for example, a laser beam, electron beam, electric arc, and/or a plasma. The build-up layer itself may be applied by means of a pulverulent, wire-shaped, and/or film-like additive. A recess may be arranged in the basic body in order to at least partially accommodate the build-up layer. The tool may be machined accordingly by means of a grinding operation, so that a cutting edge with a desired shape may be obtained.

A method for the coating of parts made of cast iron and its use may be gathered from DE4134134 A1. The coating is applied by the build-up of welding materials that are delivered in wire or pulverulent form. The aim is to prevent any external influence on the properties (for example hardness) of the transitional zone between the cast iron and the build-up layer. In order to form the build-up layer, an iron-based or iron/chromium-based alloy, in a pulverulent or wire form, is preferably welded onto the cast iron part. The alloy may have a nickel, cobalt or iron base which possesses at least one constituent of copper, chromium, silicon or boron as well as an addition of aluminum, magnesium, and/or calcium. It was found through testing that the last-mentioned additions are decisive in preventing adverse influences upon the material properties of the transitional region (for example, hardness).

Through the aforementioned combination of a cost-effective basic body with comparatively harder welding, a cutting tool may be produced which is cost effective with respect to its materials. However, the required re-machining, particularly of the hard cutting edge, is markedly more difficult and puts increased stress and wear on the corresponding tools used for the edge's production.

### BRIEF SUMMARY OF THE INVENTION

An object of this invention is a method for producing a tool for the trimming or drawing of metal sheets, which is not only cost-effective and efficient to produce, as well as durably regenerative, but also possesses a long service life

The first object is achieved by means of a method for producing a tool, comprising the provision of a metallic basic body (2), onto which a welding material (9) is welded, at least in regions, wherein the welding material (9) is composed of an alloy in % by mass of

| | |
|---|---|
| carbon (C) | 1.5-1.8% |
| vanadium (V) | 7.5-9.0% |
| chromium (Cr) | 4.5-6.0% |
| molybdenum (Mo) | 1.0-2.5% |
| nickel (Ni) | lower than (<)0.5% |
| manganese (Mn) | lower than (<)1.0% |
| silicon (Si) | lower than (<)1.0% |

as well as a remainder of iron (Fe) and melt-induced impurities.

The substantive second part of the object is achieved when the welding material (9) is welded on in order to form a cutting edge (10). Further especially advantageous refinements of the invention are disclosed in the respective subclaims, embodiments and figures.

It should be pointed out that the features listed individually in the following description may be combined with one another in any desired technically meaningful way and reveal further refinements of the invention. The description additionally characterizes and specifies the invention in connection with the figures.

According to the invention, the method for producing a sheet metal tool for the trimming and/or drawing of metal sheets comprises the provision of a metallic basic body and a build-up material that is subsequently welded, at least in regions, onto this basic body. The welding material used as the build-up material may be as hard, softer than, or harder than the material used for the basic body, depending on requirements, but it is preferable that the build-up material is harder than the basic body material. If the basic body material is harder than the welding material, the invention provides for the forming of the build-up material using an alloy which is composed of a conclusive list of the following constituents in % by mass:

| | |
|---|---|
| carbon (C) | 1.5-1.8% |
| vanadium (V) | 7.5-9.0% |
| chromium (Cr) | 4.5-6.0% |
| molybdenum (Mo) | 1.0-2.5% |
| nickel (Ni) | lower than (<)0.5% |
| manganese (Mn) | lower than (<)1.0% |
| silicon (Si) | lower than (<)1.0% |

as well as a remainder of iron (Fe) and melt-induced impurities.

The presented method makes it possible for the efficient manufacture of a tool thus described. This efficient manufacture is particularly attributable to the deliberate combination, according to the invention, of the basic body, beneficial in terms of material costs, with the build-up material. The build-up alloy, in other words the material to be welded on, is particularly advantageous in that it offers the cutting tool tempered stability and high wear resistance. The high wear resistance is predominantly attributable to the metal carbide layer which forms during application, and is still achieved even if the metal carbide layer is relatively thin.

By means of the method according to the invention, the tool is produced so that it is durably regenerative. Since the build-up material is welded on the outside of the relevant regions of the base body, the metal sheet does not come in contact with the tool's basic body. Instead, at least in the regions subjected to stress, the tool comes into contact with the metal sheet to be machined directly through its build-up layer. Any wear or outbreaks may be rectified simply and effectively by a renewed application of a build-up material made from the alloy according to the invention. The tool is therefore very easy and user friendly to repair and any subsequent repair layer has the same advantageous properties as the original coating. A long service life is then obtained through multiple repairs without the alteration of the base body.

A low-alloy basic material may be used as an advantageous material for the basic body. The basic body may be at least partially formed, for example, from 1.7140 (G47CrMn6) or Ck45 (1.1191). These materials are cost-effective and have high toughness. Cast iron with nodular graphite, more specifically globular gray cast iron or spheroidal cast iron, such as EN-JS2060 or EN-JS2070, may also be used for the basic body since their relevant properties are similar to that of steel.

The build-up material is preferably in powder form, but may also be in the form of a welding or filler wire, depending on the build-up method employed.

The build-up material may be welded on by plasma powder build-up welding (PTA=Plasma Transfer Arc Welding). The PTA technique is advantageous in that it allows for the application of a very thin layer of the build-up material on the surface of the basic body. As a result, the material properties of the basic body are not adversely modified. The PTWA method, in which a wire is melted, may also be used to apply the alloy described in the invention. Only a small melting depth is obtained when these methods are used in conjunction with build-up materials in powder form. This results in only minor intermixing between the material of the basic body and the build-up material. By limiting the intermixing of the materials, an overall improved and particularly desired material behavior is achieved.

An alternative welding method may also be envisaged in order to apply the build-up material. The welding material may also be welded on by means of filler wire welding. Further alternative welding methods may include, but are not limited to, laser welding, metal inert gas welding (MIG), metal active gas welding (MAG), tungsten inert gas welding (WIG) or open arc welding (OA).

The build-up material may be welded on in order to form a cutting edge that has a hardness identical to or different from that of the basic body. The build-up material may also be welded on to camber the basic body. The latter may useful when producing drawing tools. Hereafter, build-up material is equated with welding material and application is equated with welding on. By welding the build-up material onto the basic body in order to form a cutting edge, the regions of the basic body which come into contact with the metal sheet to be trimmed may be made wear-resistant. It is possible to apply a thin layer of welding material to the basic body, and dispense with the unnecessary buffer layer, by using PTA welding. The basic body may thereby, if required, be cambered in a directed manner.

The possibility of applying the welding material thinly allows for the rapid and directed tailoring of the tool, so as to improve the flow behavior of the metal sheets being formed. This is particularly useful when discussing drawing tools. A directed local use of the necessary welding on of material is made possible by means of PTA welding. The hardening of the overall basic body is not necessary because only part of the tool comes into contact with the metal sheet. The application of the wear-resistant welding material may thus take place in very thin form and, in particular, may remain free of any spatters.

According to the invention, it is preferable for the cutting edge to be formed on the edge of the cutting tool. For this purpose, the basic body preferably has a chamfer on at least one of its edges. Alternatively, the edge of the basic body may also possess a subradius or a combination of a chamfer and a subradius. The configured edge of the cutting tool is then welded on, at least in regions, by means of the welding material, in order to form the cutting edge.

If the welding material is welded on in a plurality of plies, the multiple-ply build-up of a plurality of thin build-up layers results, in spite of the ideally buffer layer-free implementation, in only minor intermixing of the welding material with the material of the basic body. In the context of the invention, the actual build-up material is welded to the buffer layer. This invention ideally dispenses with the buffer layer.

As a further advantageous measure, the welding material, after being welded on, may be machined by a chip-removing method. For example, milling may be used. Since a desired and, in particular, dimensionally stable tool is not always produced through the application of the welding material, the possibility of subsequent simple machining is especially important. It was found through testing that the composition, according to the invention, allows for the combination of the otherwise incompatible properties of high wear resistance and superior machinability in the welded-on region or regions.

The above-presented method produces a cutting or drawing tool for the trimming or drawing of metal sheets, and provides longevity through the regenerative machining of the cutting edge. Another advantage comes from the use of a basic body made of a cost-effective material in combination with an add-on alloy that is used as a welded on welding material. Particularly in combination with PTA welding, simple manufacture and subsequent repair of a worn or damaged tool are obtained.

According to the invention, the tool is only in contact with the metal sheets that need to be trimmed in the regions where the welding material has been applied. The basic body merely serves as a shaped supporting body for receiving the wear-resistant welding material. By virtue of the tool's simple repair possibility, a tool manufactured in this way may be employed for an extended period of time. For example, a tool manufactured in this way could participate in the manufacture of sheet metal parts for the automotive industry during the entire running time of a model. This results in extremely efficient manufacturing, since costly sheet metal tools will be exchanged less frequently. A standard in-house tool shop could perform the necessary repair on these tools since the alloy, according to the invention, is machinable by conventional manufacturing methods.

This also applies to the cambering of the drawing tools thus produced. The combination of the welding material, according to the invention, and PTA welding makes it possible to apply a very thin and clean layer which may be easily re-machined in spite of its high wear resistance. As a result, rapid and high-quality tailoring of the tool is made possible. Due to the high wear resistance of the welded-on welding material, any need for re-machining is reduced to a minimum and the overall service life of the drawing tool is increased.

The invention produces a tool for the trimming or drawing of metal sheets. The tool comprises a metallic basic body and a welding material welded, at least in regions, onto the basic body. When the welding material is harder than that of the basic body, the welding material has an alloy in % by mass of:

| | |
|---|---|
| carbon (C) | 1.5-1.8% |
| vanadium (V) | 7.5-9.0% |
| chromium (Cr) | 4.5-6.0% |
| molybdenum (Mo) | 1.0-2.5% |
| nickel (Ni) | lower than (<)0.5% |
| manganese (Mn) | lower than (<)1.0% |
| silicon (Si) | lower than (<)1.0% |

as well as a remainder of iron (Fe) and melt-induced impurities.

The welding material is welded on in order to form a cutting edge which is harder, the same as or even softer than the basic body. Alternatively to or in combination with this, the welding material may also be welded onto the basic body and cambered. This is particularly the case when the tool, according to the invention, is configured as a drawing tool. The basic body preferably has a chamfer or a subradius at one of its edges where the welding material can be welded on in order to form a cutting edge. Depending on the tool's requirements and configuration, the welding material may be welded onto the basic body in a plurality of plies.

The advantages arising from the abovementioned features have already been sufficiently described in the context of the method-related part of the present invention, and therefore reference is made at this juncture to those statements.

Some advantages of the invention are cost reduction (material costs of the basic material), simple implementation in manufacturing, and the ease of repair (toolmaking shop). From their first use, the tools are provided with the newly developed coating in the correct regions. Only the welding material is in contact with the metal sheet, so that the beneficial basic material performs only a supporting action. The alloy development is conducive to tempering resistance (with a maximum secondary hardness) and achieves high wear resistance, predominantly due to the carbides that form during welding. The deliberate size of the carbides in the matrix does not allow rapid outbreak, and therefore allows for a service life comparable to or better than high-alloy tools. The embedding of homogeneously distributed fine, hard phases in the metallic matrix of the build-up layer contributes to wear resistance.

The tool may be employed throughout the entire running time of a model since it may be easily repaired. Finally, the applied alloy may be conventionally machined in tool making shops of manufacturing plants. The differences in present-day cambering are mainly in the build-up height. By employing PTA welding, which allows the application of very thin and clean layers, in combination with simple re-machining and high wear resistance, rapid and high-quality tailoring of the tools is made possible. This rapid and high-quality tailoring saves time in tailoring and reduces the amount of re-working during the tools production, thereby increasing the service life of the tool.

Further advantageous particulars and effects of the invention are explained in more detail below by means of some exemplary embodiments that are illustrated diagrammatically in the following figures.

### BRIEF DESCRIPTION OF THE FIGURES

FIG. 1 shows a tool, according to the invention, in the form of a cutting tool in a perspective illustration.

FIG. 2 shows the cutting tool from FIG. 1 in a side view.

FIG. 3 shows an alternative embodiment of the cutting tool from FIG. 2 in the same type of illustration.

FIG. 4 shows the cutting tool from FIG. 1 with welded-on welding material for forming a cutting edge in a perspective illustration.

FIG. 5 shows a portion of a tool according to the invention in a sectional illustration.

### DETAILED DESCRIPTION OF THE INVENTION

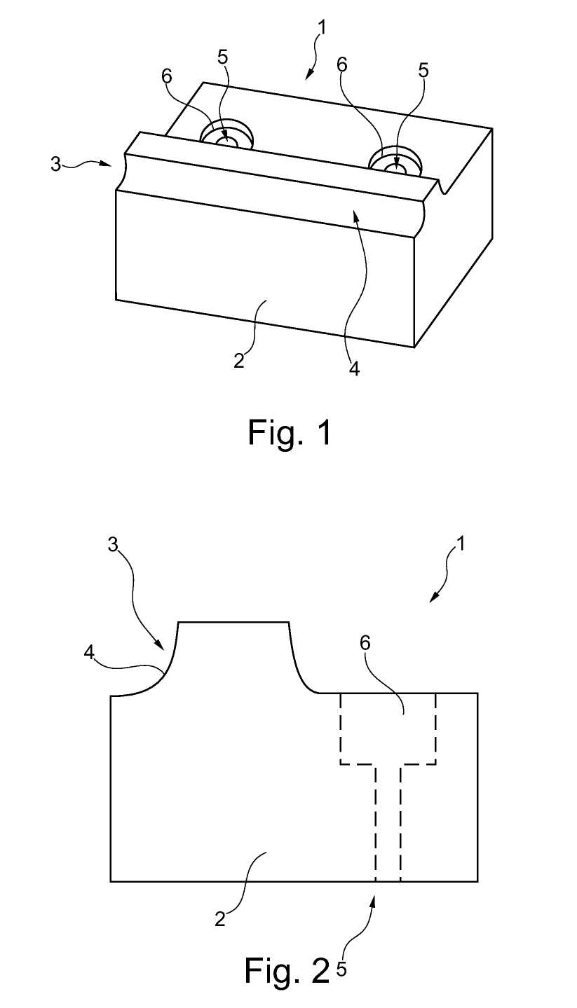

FIG. 1 diagrammatically illustrates a cutting tool (1), according to the invention, for the trimming of metal sheets, not shown in any more detail. The cutting tool (1) is intended to be coupled to a device, likewise not illustrated in any more detail, when machining a metal sheet. The cutting tool (1) is comprised of a basic body (2) which has a continuous subradius (4) at an end-face edge (3). In order to couple the basic body (2) to the device, not illustrated, for the machining of the metal sheet, the basic body has, in the present case, two through bores (5), each with a blind hole (6). The through bores (5) are provided for receiving screws, not shown here, via which the basic body (2) may be connected to the device. The blind holes (6) receive the screw head, the latter being counter-sinkable inside the blind holes (6).

FIG. 2 shows the cutting tool (1) in a side view. In this illustration, the form of the subradius (4) at the edge (3) of the basic body (2) may also be seen. The profile of one of the through bores (5), together with the associated blind hole, is indicated via dashed lines.

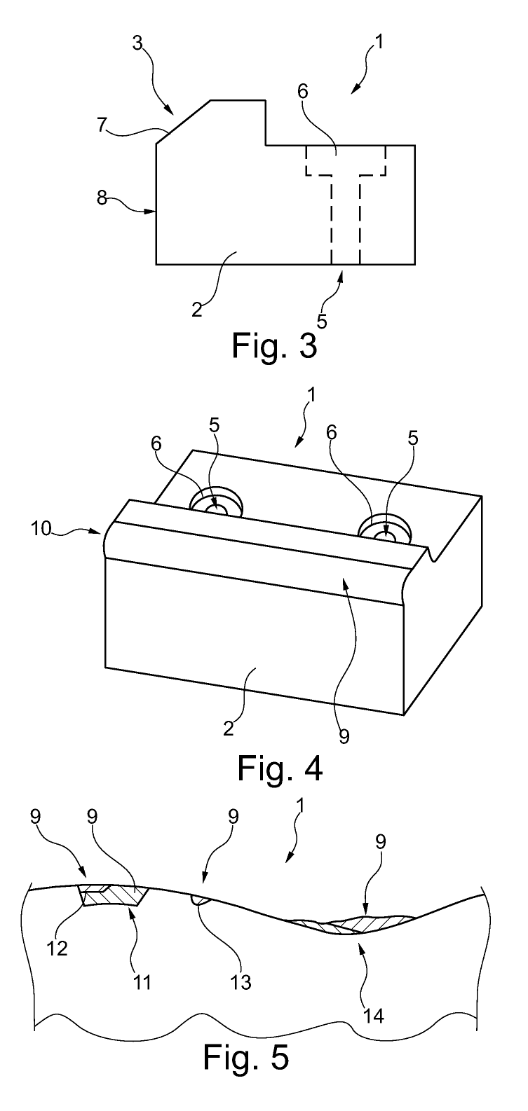

An alternative embodiment of the cutting tool (1) from FIGS. 1 and 2 may be gathered from FIG. 3. The cutting tool (1) shown here differs in the design at the edge (3) of the basic body (2). The edge in FIG. 3 is not provided with a subradius (4), but instead with a chamfer (7). The chamfer (7) in the figure is inclined at 45° with respect to an end face (8) of the basic body (2).

In FIG. 4, both the subradius (4) and the chamfer (7) are provided at the respective edge (3) of the basic body in order to form a cutting edge (10) through the application of a welding material (9). The welding material (9) is welded into the subradius (4) or, as shown here, onto the chamfer (7), in a way not shown in more detail, by means of a PTA welding method.

The welding material (9) is an alloy composed of the following alloy partners in % by mass of:

| | |
|---|---|
| carbon (C) | 1.5-1.8% |
| vanadium (V) | 7.5-9.0% |
| chromium (Cr) | 4.5-6.0% |
| molybdenum (Mo) | 1.0-2.5% |
| nickel (Ni) | lower than (<)0.5% |
| manganese (Mn) | lower than (<)1.0% |
| silicon (Si) | lower than (<)1.0% |

as well as a remainder of iron (Fe) and melt-induced impurities

The welding material (9) is machinable after its application, in a way not illustrated in any more detail. For example, it may be machined by means of a chip-removing method such as milling.

FIG. 5 shows a portion of a tool, which could represent a drawing tool or the cutting tool (1) from the previous FIGS. 1 to 4, as a cross-section. The basic body (2) has a depression (11) into which the welding material (9) is introduced. FIG. 5 is intended to illustrate the simple possibility of repairing or regenerating a tool (1) of any configuration. The welding material (9) introduced into the depression (11) has an outbreak (12) which has been filled anew with the welding material (9) by the simple means of PTA welding. Any outbreak (13) on the surface of the basic body (2) can also be repaired in this way and, in the present case, has likewise been filled with the welding material (9) described in the invention.

A valley (14) may be seen within the basic body (2). The basic body (2) has been cambered in the region of the valley (14). For this purpose, the welding material (9) was applied superficially to a subregion of the valley (14).

### LIST OF REFERENCE SYMBOLS

1 Tool

2 Basic body of 1

3 Edge of 2

4 Subradius on 3

5 Through bore in 2

6 Blind hole of 5

7 Chamfer on 3

8 End face of 2

9 Welding material

10 Cutting edge of 1

11 Depression in 2

12 Outbreak in 9

13 Outbreak in 2

14 Valley in 2

What is claimed:

1. An alloy composition for a welding material useful for a wear resistant cutting surface of a metal forming tool consisting of:

| | |
|---|---|
| carbon (C) | 1.5-1.8% |
| vanadium (V) | 7.5-9.0% |
| chromium (Cr) | 4.5-6.0% |
| molybdenum (Mo) | 1.0-2.5% |
| nickel (Ni) | lower than (<)0.5% |
| manganese (Mn) | lower than (<)1.0% |
| silicon (Si) | lower than (<)1.0% |

as well as a remainder of iron (Fe) and melt-induced impurities.

2. A tool for the machining metal sheets, comprising:
a metallic basic body having a cutting edge, and
an alloy welding material welded to said cutting edge, wherein said welding material consists of:

| | |
|---|---|
| carbon (C) | 1.5-1.8% |
| vanadium (V) | 7.5-9.0% |
| chromium (Cr) | 4.5-6.0% |
| molybdenum (Mo) | 1.0-2.5% |
| nickel (Ni) | lower than (<)0.5% |
| manganese (Mn) | lower than (<)1.0% |
| silicon (Si) | lower than (<)1.0% |

as well as a remainder of iron (Fe) and melt-induced impurities.
